(19) United States
(12) Patent Application Publication
(10) Pub. No.: US 2011/0037659 A1
(43) Pub. Date: Feb. 17, 2011

(54) ANTENNA APPARATUS

(75) Inventors: Masahiro Yanagi, Shinagawa (JP); Shigemi Kurashima, Shinagawa (JP); Hideaki Yoda, Shinagawa (JP)

Correspondence Address: IPUSA, P.L.L.C, 1054 31ST STREET, N.W., Suite 400, Washington, DC, 20007, US

(73) Assignee: FUJITSU COMPONENT LIMITED, Tokyo (JP)

(21) Appl. No.: 12/851,648

(22) Filed: Aug. 6, 2010

(30) Foreign Application Priority Data
Aug. 14, 2009 (JP) 2009-187940

(51) Int. Cl. H01Q 1/38

(52) U.S. Cl. 343/700 MS

(57) ABSTRACT

An antenna apparatus includes a dielectric substrate having first and second rectangular regions on a surface of the dielectric substrate, an antenna element formed inside the first rectangular region, and a ground element formed inside the second rectangular region, the ground element having a proximity side positioned proximate to and along a borderline between the first and second rectangular regions. The antenna element includes a first elongation extending from a first end to a second end, the first end including a power feed part positioned proximate to a side edge of the proximity side, the second end being positioned proximate to an upper side of the first rectangular region facing the borderline, a second elongation extending from the second end in a direction along the upper side, and a stub part extending from the second end in a direction opposite to the extending direction of the second elongation.

### BACKGROUND OF THE INVENTION

1. Field of the Invention

The present invention generally relates to an antenna apparatus.

2. Description of the Related Art

Because it is sufficient for the length of an antenna element of a monopole type antenna apparatus to be ¼ the length of a wavelength of the frequency used by the monopole type antenna apparatus, monopole type antenna apparatuses are used in data communications by small type electronic communication devices such as personal computers, mobile phones, and audio devices.

On the other hand, antenna apparatuses capable of transmitting large amounts of data are used in, for example, a 2.4 GHz band of Blue Tooth (Registered Trademark) standardized by IEEE 802.15 or a wireless LAN (Local Area Network) standardized by IEEE 802.11.

Due to the increase in the amount of data in recent years, various modifications have been made on conventional antenna apparatuses for achieving small size and large bandwidth (see, for example, Japanese Laid-Open Patent Publication No. 2002-92576).

However, size reduction and bandwidth increase could not be sufficiently attained with the conventional antenna apparatuses.

### SUMMARY OF THE INVENTION

The present invention may provide an antenna apparatus that substantially eliminates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an antenna apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an antenna apparatus including a dielectric substrate having first and second rectangular regions on a surface of the dielectric substrate, an antenna element formed inside the first rectangular region, and a ground element formed inside the second rectangular region, the ground element having a proximity side positioned proximate to and along a borderline between the first and second rectangular regions, wherein the antenna element includes a first elongation extending from a first end to a second end, the first end including a power feed part positioned proximate to a side edge of the proximity side, the second end being positioned proximate to an upper side of the first rectangular region facing the borderline, a second elongation extending from the second end in a direction along the upper side, and a stub part extending from the second end in a direction opposite to the extending direction of the second elongation.

Other objects and further features of the present invention will be apparent from the following detailed description when read in conjunction with the accompanying drawings.

### BRIEF DESCRIPTION OF THE DRAWINGS

FIG. 1 is a plan view illustrating an antenna apparatus according to an embodiment of the present invention;

FIG. 2A is a graph illustrating VSWR (Voltage Standing Wave Ratio) characteristics of an antenna apparatus according to a first embodiment of the present invention;

FIG. 2B is a graph illustrating directivity of an antenna apparatus according to the first embodiment of the present invention;

FIG. 2C is a table illustrating the maximum gain and the average gain of an antenna apparatus according to the first embodiment of the present invention with respect to frequency;

FIG. 3A is a plan view illustrating a state where a communication module is mounted on an antenna apparatus according to the first embodiment of the present invention;

FIG. 3B is a side view of the antenna apparatus illustrated in FIG. 3A;

FIG. 4 is a plan view illustrating a configuration of an antenna apparatus according to a second embodiment of the present invention;

FIG. 5A is a graph illustrating VSWR characteristics of an antenna apparatus according to the second embodiment of the present invention;

FIG. 5B is a graph illustrating directivity of an antenna apparatus according to the second embodiment of the present invention;

FIG. 5C is a table illustrating the maximum gain and the average gain of an antenna apparatus according to the second embodiment of the present invention with respect to frequency;

FIG. 6 is a plan view illustrating an antenna apparatus according to a third embodiment of the present invention;

FIGS. 7A-7C are circuit diagrams illustrating an antenna apparatus according to the third embodiment of the present invention;

FIG. 8A is a plan view illustrating an antenna apparatus according to a fourth embodiment of the present invention;

FIG. 8B is a side view of an antenna apparatus according to the fourth embodiment of the present invention; and

FIG. 8C is a perspective view of the antenna apparatus according to the fourth embodiment of the present invention.

### DESCRIPTION OF THE PREFERRED EMBODIMENTS

In the following, embodiments of an antenna apparatus of the present invention are described with reference to the accompanying drawings.

### First Embodiment

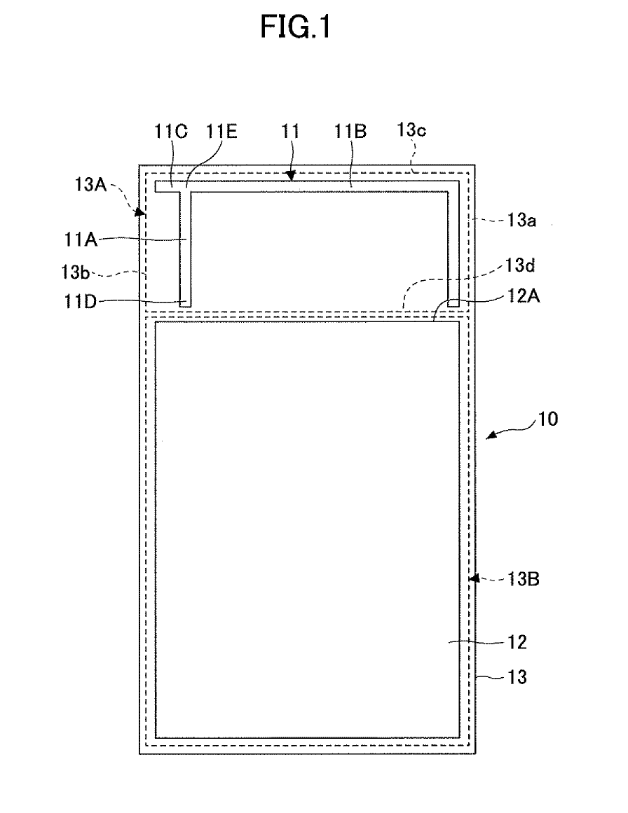

FIG. 1 is a plan view illustrating an antenna apparatus 10 according to an embodiment of the present invention.

The antenna apparatus 10 according to the first embodiment of the present invention includes an antenna element 11 and a ground element 12. The antenna element 11 and the ground element 12 are both planar members formed on the same plane of a substrate 13. For example, the antenna element 11 and the ground element 12 may be formed of copper foil. The substrate 13 is formed of a dielectric material. For example, the substrate 13 may be a FR4 substrate formed of glass epoxy.

The antenna element 11 includes a first elongation part 11A, a second elongation part 11B, and a stub part 11C. Because the first elongation part 11A in this embodiment is formed having a straight shape, the first elongated part 11A in this embodiment is referred to as a straight part 11A. Because the second elongation part 11B in this embodiment is formed having an inverted L-shape when viewed from above (plan view), the second elongated part 118 in this embodiment is referred to as an inverted L-shape part 11B. The antenna element 11 is formed inside a first rectangular region 13A on the surface of the substrate 13. The first rectangular region 13A includes a right short side 13a, a left short side 13b, an upper side 13c, and a lower side 13d.

The ground element 12, which has a rectangular shape when viewed from above (plan view), is formed inside a second rectangular region 13B on the surface of the substrate 13. The second rectangular region 13B is the remaining region excluding the first rectangular region 13A from the surface of the substrate 13.

The ground element 12 includes a proximity side 12A situated proximate to and along a borderline between the first rectangular region 13A and the second rectangular region 13B.

The straight part 11A of the antenna element 11 includes a power feed part 110. The power feed part 110 is provided on one end of the straight part 11A proximate to the proximity side 12A. Electric power is supplied to the power feed part 11D from an outside power source (not illustrated). The inverted L-shape part 11B is connected to the other end 11B of the straight part 11D (the end of the straight part 11D proximate to the upper side 13c of the first rectangular region 13A). The inverted L-shape part 11B extends from the other end 11B along the upper side 13c of the first rectangular region 13A and bends in a direction along the right short side 13a of the first rectangular region 13A in a manner so that a distal end of the inverted L-shape part 11B is situated proximate to a right side edge of the proximity side 12A.

The stub part 11C is elongated from the other end 11E of the straight part 11A in a direction opposite to the extending direction of the inverted L-shape part 11B, such that the stub part 11C is positioned proximate to the left short side 13b of the first rectangular area 13A.

For example, the antenna element 11 may have a length of approximately 15 mm, which is substantially equivalent to the total length of the straight part 11A and the inverted L-shape part 11B. Further, the antenna element 11 may have a thickness of, for example, approximately 0.1 mm. For the sake of explanation, the ground element 12 is illustrated having a rectangular shape inside the second rectangular region 13B in FIG. 1. However, the ground element 12 may be formed (patterned) having other shapes (patterns) inside the second rectangular region 13B so that communication modules or the like can be mounted thereon.

For example, a high frequency voltage of approximately 2.4-2.5 GHz is applied to the antenna apparatus 10.

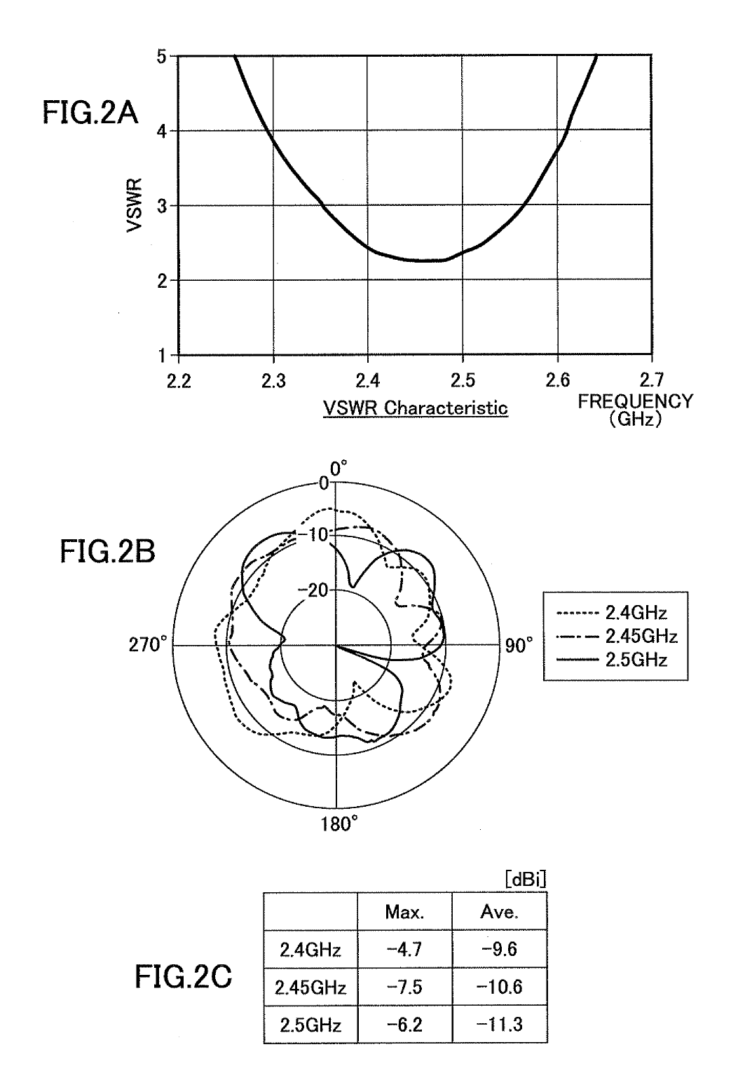

FIG. 2A is a graph illustrating VSWR (Voltage Standing Wave Ratio) characteristics of the antenna apparatus 10 according to the first embodiment of the present invention. FIG. 2B is a graph illustrating directivity of the antenna apparatus 10 according to the first embodiment of the present invention. FIG. 2C is a table illustrating the maximum gain and the average gain of the antenna apparatus 10 according to the first embodiment of the present invention with respect to frequency.

As illustrated in FIG. 2A, the antenna apparatus 10 has a satisfactory VSWR of approximately 2.2-2.3 in a frequency range between 2.4 GHz and 2.5 GHz. The graph of FIG. 2A illustrates that the antenna apparatus 10 exhibits little reflection in the frequency range between 2.4 GHz and 2.5 GHz. Accordingly, the antenna apparatus 10 is suitable for communications in the frequency range between 2.4 GHz and 2.5 GHz.

As illustrated in FIG. 2B, a directivity value of approximately −10 dBi (decibels relative to isotropic) is evenly obtained in the cases where frequencies are 2.4 GHz, 2.45 GHz, and 2.5 GHz, respectively. The graph of FIG. 2B illustrates that the antenna apparatus 10 has satisfactory directivity. In FIG. 2B, directivity is measured using a vertical antenna with vertical polarization.

As illustrated in FIG. 2C, the highest value of gain (maximum gain) is −4.7 dBi at a frequency of 2.4 GHz, −7.5 dBi at a frequency of 2.45, and −6.2 dBi at a frequency of 2.5 GHz. Among the frequencies of 2.4 GHz, 2.45 GHZ, and 2.5 GHz, the highest value of gains is obtained at the frequency of 2.4 GHz.

As illustrated in the directivity of FIG. 2B, the antenna apparatus 10 has a gain which hardly exhibits any drastic decreases and a satisfactory directivity which has few null points.

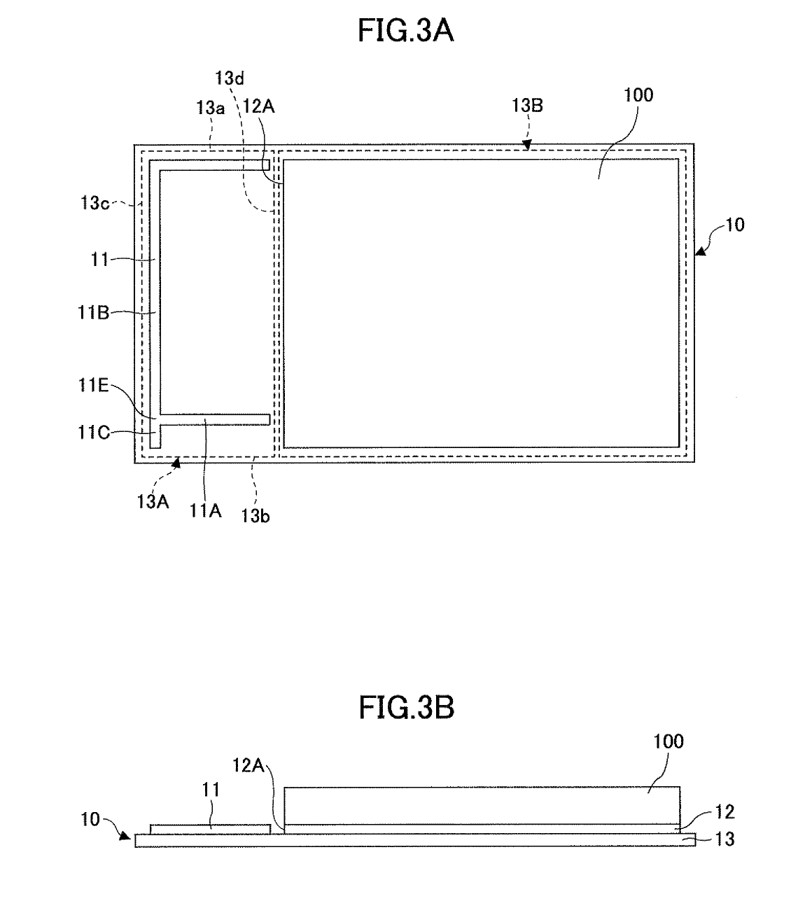

FIG. 3A is a plan view illustrating a state where a communication module 100 is mounted on the antenna apparatus 10 according to the first embodiment of the present invention. FIG. 3B is a side view of the antenna apparatus 10 illustrated in FIG. 3A.

In one embodiment, the one end of the straight part 11A may be extended further toward the proximity side 12A, so that the power feed part 11D of the antenna element 11 (see FIG. 1) is in a position hidden beneath the communication module 100 (e.g., position beneath an upper left corner part of the communication module 100 in FIG. 35) and receive power from the communication module 100. The ground element 12 (see FIG. 1) is connected to a lower side of the communication module 100.

Hence, the above-described antenna apparatus 10 according to the first embodiment of the present invention can be formed in a small size and provide wide bandwidth.

Although the second elongation part 11B of the antenna element 11 in this embodiment is described as the inverted L-shape part, the second elongation part 115 may alternatively be formed having an inverted F-shape including an additional short stub (thus, referred to as an “inverted F-shape part”).

### Second Embodiment

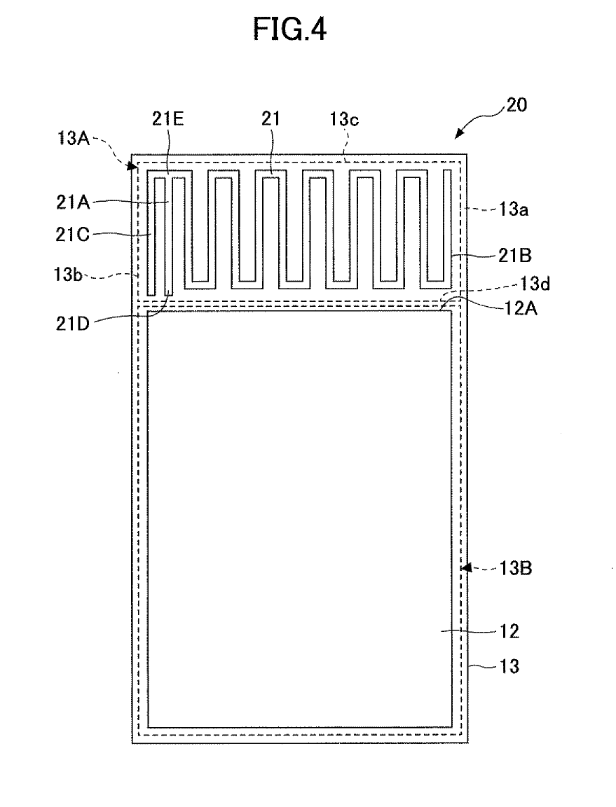

FIG. 4 is a plan view illustrating a configuration of an antenna apparatus 20 according to the second embodiment of the present invention. As described below, the antenna apparatus 20 of the second embodiment is different from the antenna apparatus 10 of the first embodiment in that a second elongation part 21B and a stub part 21C of the second embodiment have different shapes from the second elongation part 11B and the stub part 11C of the first embodiment. Other than this difference, the configuration of the antenna apparatus 20 of the second embodiment is the same as that of the antenna apparatus 10 of the first embodiment. Therefore, in the second embodiment, like components are denoted with like reference numerals as those of the first embodiment and are not further explained.

The antenna apparatus 20 has an antenna element 21 including a meandering part 21B (serving as the second elongation part) and a stub part 21C.

The antenna element 21 also includes a straight part 21A. The straight part 21A includes a power feed part 21D. The power feed part 21D is provided on one end of the straight part 21A proximate to the proximity side 12A of the ground element 12.

The meandering part 21B is connected to a right side of the other end of the straight part 21A. The stub part 21C is connected to a left side of the other end of the straight part 21A.

The meandering part 21B is used as the second elongation part as an alternative of the inverted L-shape part 11B of the first embodiment. The meandering part 21B is formed having a meander shape inside the first rectangular region 13A. The number of bends formed in the meandering part 21B is not limited to the number of bends illustrated in FIG. 4.

The stub part 21C is bent along the left side of the first rectangular region 13A toward the left side edge of the proximity side 12A of the ground element 12.

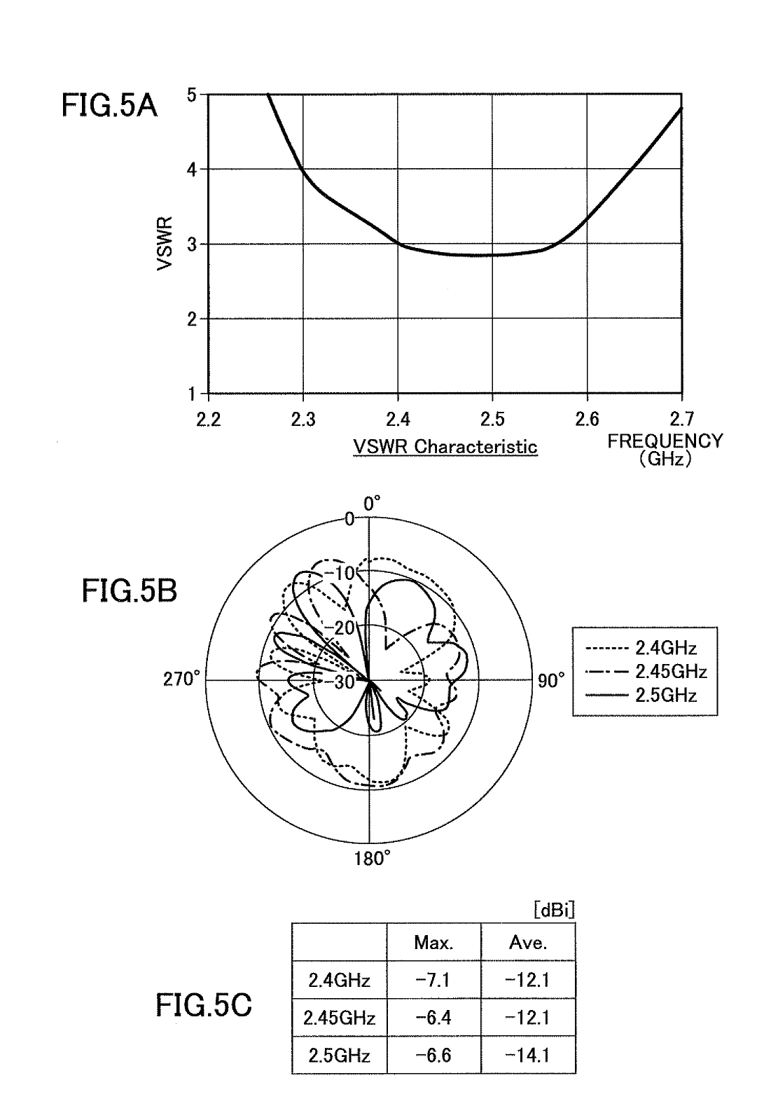

FIG. 5A is a graph illustrating the VSWR characteristics of the antenna apparatus 20 according to the second embodiment of the present invention. FIG. 5B is a graph illustrating directivity of the antenna apparatus 20 according to the second embodiment of the present invention. FIG. 5C is a table illustrating the maximum gain and the average gain of the antenna apparatus 20 according to the second embodiment of the present invention with respect to frequency.

As illustrated in FIG. 5A, the antenna apparatus 20 has a satisfactory VSWR of approximately 2.8-3.0 in a frequency range between 2.4 GHz and 2.5 GHz. The graph of FIG. 5A illustrates that the antenna apparatus 20 exhibits little reflection in the frequency range between 2.4 GHz and 2.5 GHz. Accordingly, the antenna apparatus 20 is suitable for communications in the frequency range between 2.4 GHz and 2.5 GHz.

As illustrated in FIG. 5B, a directivity value of approximately −10 dBi is obtained in the cases where frequencies are 2.4 GHz, 2.45 GHz, and 2.5 GHz, respectively. Although the antenna apparatus 20 exhibits less evenness than that of the antenna apparatus 10 of the first embodiment, the graph of FIG. 5B illustrates that the antenna apparatus 20 has satisfactory directivity.

As illustrated in FIG. 5C, the highest value of gain (maximum gain) is −7.1 dBi at a frequency of 2.4 GHz, −6.4 dBi at a frequency of 2.45, and −6.6 dBi at a frequency of 2.5 GHz. Among the frequencies of 2.4 GHz, 2.45 GHZ, and 2.5 GHz, the highest value of gain is obtained at the frequency of 2.45 GHz. Further, the average value of gain (average gain) is −12.1 dBi at the frequency of 2.4 GHz, −12.1 dBi at the frequency of 2.45 GHz, and −14.1 dBi. Among the frequencies of 2.4 GHz, 2.45 GHZ, and 2.5 GHz, the average gain in the case using a frequency of 2.4 GHz or 2.45 GHz is greater than the case using a frequency of 2.5 GHz.

As illustrated in the directivity of FIG. 5B, the reason that the antenna apparatus 20 has a greater tendency of exhibiting decrease of gain compared to the antenna apparatus 10 is because there are more portions in the second elongation part (meandering part 21B) that are situated proximate to the proximity side 12A of the ground element 21. This increases coupling between the antenna element 21 and the ground element 12. Nevertheless, the antenna apparatus 20 exhibits a satisfactory directivity and a value of approximately −10 dBi can be obtained with the antenna apparatus 20.

Hence, the above-described antenna apparatus 20 according to the second embodiment of the present invention can be formed in a small size and provide wide bandwidth.

### Third Embodiment

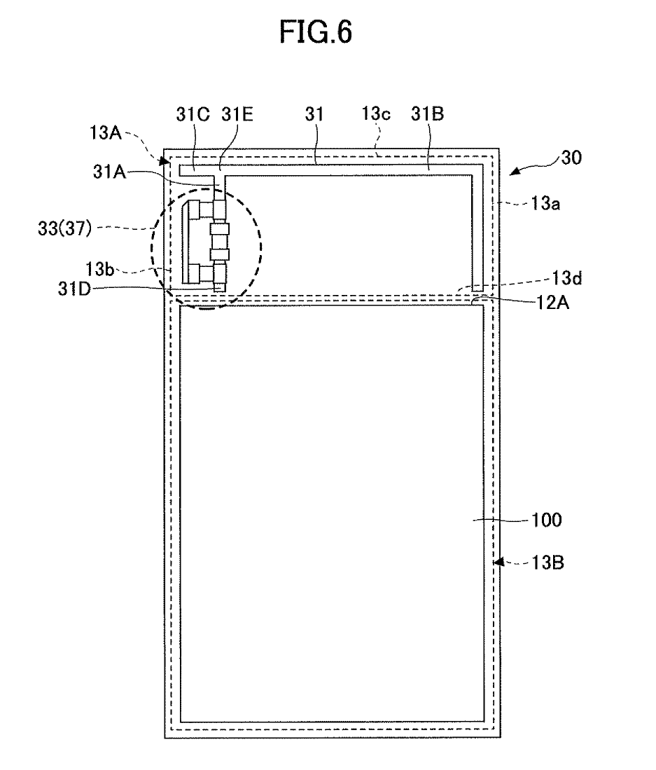

FIG. 6 is a plan view illustrating an antenna apparatus 30 according to a third embodiment of the present invention. The antenna apparatus 30 includes a straight part 31A of an antenna element 31 into which a matching element such as a matching circuit 33 or an attenuator 37 is inserted.

Similar to the antenna element 11 of the first embodiment, the antenna element 31 also includes the straight part 31A, an inverted L-shape part 31B, and a stub part 31C. The straight part 31A includes a power feed part 31D proximate to the proximity side 12A of the ground element 12. The power feed part 31D is provided on one end of the straight part 31A proximate to the proximity side 12A. The inverted L-shape part 31B is formed on the right side of the other end 31E of the straight part 31A. The stub part 31C is formed on the left side of the other end 31E of the straight part 31A.

The matching circuit 33 or the attenuator 37 is inserted between the power feed part 31D and the other end 31E of the straight part 31.

Next, the matching circuit 33 and the attenuator 37 according to the third embodiment of the present invention are described.

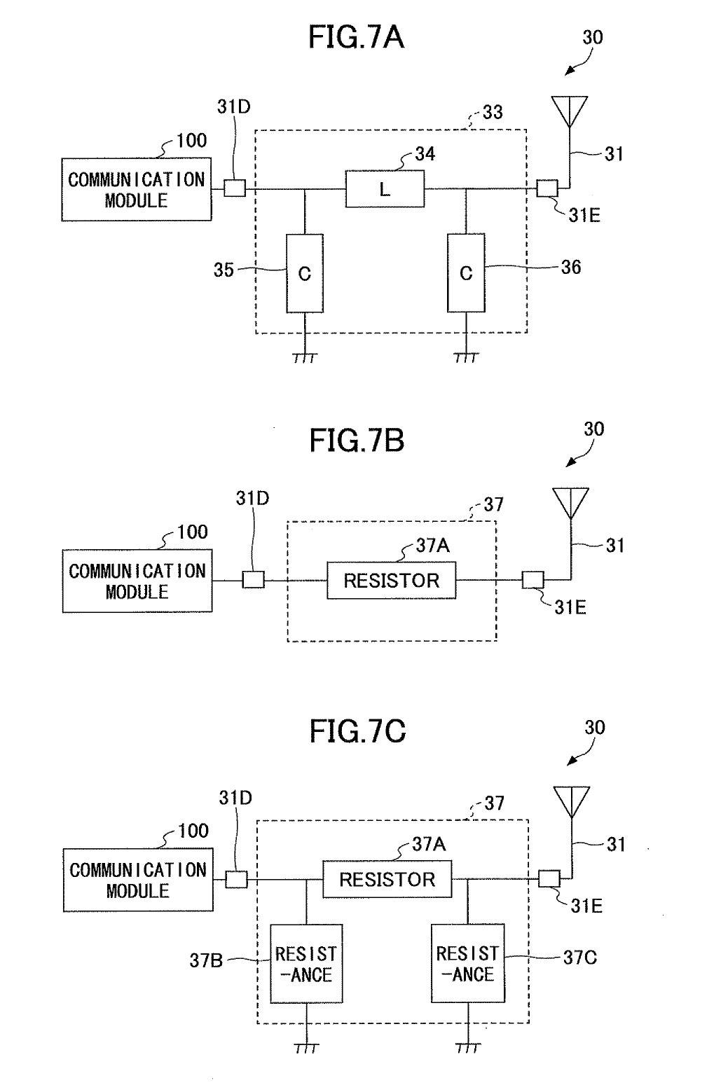

FIGS. 7A-7C are circuit diagrams illustrating the antenna apparatus 30 according to the third embodiment of the present invention.

As illustrated in FIG. 7A, the matching circuit 33 in this embodiment is a π type matching circuit including a coil 34 and a pair of capacitors 35, 36. Although the matching circuit 33 in the third embodiment includes the pair of capacitors 35, 36, either one of the capacitors 35, 36 or neither one of the capacitors 35, 36 may be included in the matching circuit 33.

As illustrated in FIG. 7B, the attenuator 37 in this embodiment has a single resistor 37A placed between the power feed part 31D and the other end 31E of the straight part 31. Accordingly, the resistor 37A is connected in series with the power feed part 31D and the other end 31E of the straight part 31.

As illustrated in FIG. 7C, the attenuator 37 may be a π type circuit including resistors 37A-37C. Although the attenuator 37 includes capacitors 37B and 37C, either one of the capacitors 37B, 37C or neither of the capacitors 37B, 37C may be included in the attenuator 37.

In general, the attenuator 37 having the configuration illustrated in FIG. 7B or FIG. 7C enables the communication bandwidth to become wider compared to that of the matching circuit 33 illustrated in FIG. 7A. Accordingly, the configuration of the matching circuit 33 or the attenuator 37 may be optimized depending on the purpose of usage.

Hence, the above-described antenna apparatus 30 according to the third embodiment of the present invention can easily match impedance by using the matching circuit 33. Likewise, the above-described antenna apparatus 30 according to the third embodiment of the present invention can easily match impedance by using the attenuator 37.

### Fourth Embodiment

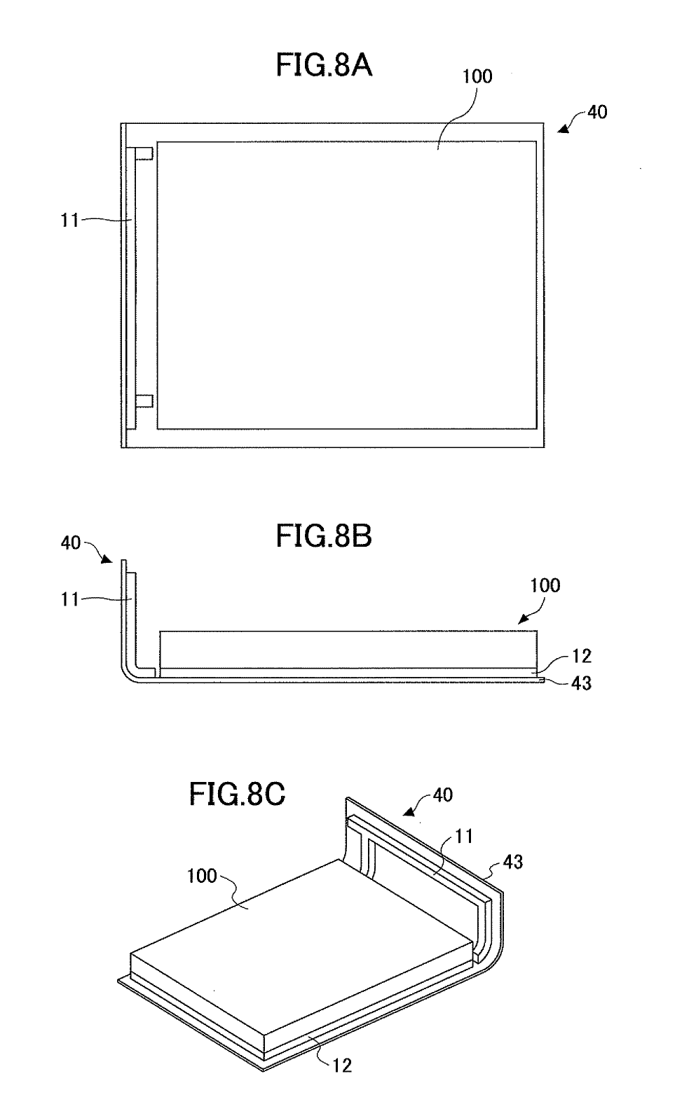

FIG. 8A is a plan view illustrating an antenna apparatus 40 according to a fourth embodiment of the present invention. FIG. 8B is a side view of the antenna apparatus 40 according to the fourth embodiment of the present invention. FIG. 8C is a perspective view of the antenna apparatus 40 according to the fourth embodiment of the present invention. The antenna apparatus 40 is different from the antenna apparatus 10 in that the antenna apparatus 40 is formed on a flexible substrate 43. Other than this difference, the configuration of the antenna apparatus 40 of the fourth embodiment is the same as that of the antenna apparatus 10 of the first embodiment. Therefore, in the fourth embodiment, like components are denoted with like reference numerals as those of the first embodiment and are not further explained.

The flexible substrate 43 is formed of, for example, polyimide. Because the flexible substrate 43 is bendable, a part of the flexible substrate 43 on which the antenna element 11 is mounted can be positioned substantially orthogonal to the communication module 100, as illustrated in, for example, FIG. 8B. That is, a part of the substrate 43 corresponding to the first rectangular region 13A can be positioned upright with respect to a part of the substrate 43 corresponding to the second rectangular region 13B.

Hence, the above-described antenna apparatus 40 according to the fourth embodiment of the present invention can be formed in a small size. Further, by bending the flexible substrate 43 as illustrated in, for example, FIG. 8B, adjustments can be made according to the shape or size of the communication apparatus or the like to be mounted on the flexible substrate 43.

Further, the present invention is not limited to these embodiments, but variations and modifications may be made without departing from the scope of the present invention.

The present application is based on Japanese Priority Application No. 2009-187940 filed on Aug. 14, 2009, with the Japanese Patent Office, the entire contents of which are hereby incorporated by reference.

What is claimed is:

1. An antenna apparatus comprising:
a dielectric substrate having first and second rectangular regions on a surface of the dielectric substrate;
an antenna element formed inside the first rectangular region; and
a ground element formed inside the second rectangular region, the ground element having a proximity side positioned proximate to and along a borderline between the first and second rectangular regions;
wherein the antenna element includes
a first elongation extending from a first end to a second end, the first end including a power feed part positioned proximate to a side edge of the proximity side, the second end being positioned proximate to an upper side of the first rectangular region facing the borderline,
a second elongation extending from the second end in a direction along the upper side, and
a stub part extending from the second end in a direction opposite to the extending direction of the second elongation.

2. The antenna apparatus as claimed in claim 1, wherein the second elongation has an inverted L-shape.

3. The antenna apparatus as claimed in claim 1, wherein the second elongation has an L-shape.

4. The antenna apparatus as claimed in claim 1, wherein the second elongation has an inverted F-shape.

5. The antenna apparatus as claimed in claim 1, wherein the second elongation has a meandering shape.

6. The antenna apparatus as claimed in claim 1, further comprising:
a matching element inserted into the first elongation.

7. The antenna apparatus as claimed in claim 1, further comprising a matching circuit inserted into the first elongation.

8. The antenna apparatus as claimed in claim 1, further comprising an attenuator inserted into the first elongation.

9. The antenna apparatus as claimed in claim 1, wherein a part of the dielectric substrate corresponding to the first rectangular region is configured to be positioned upright with respect to a part of the dielectric substrate corresponding to the second rectangular region.
